(19) United States
(12) Patent Application Publication
(10) Pub. No.: US 2007/0123384 A1
(43) Pub. Date: May 31, 2007

(54) Electrodynamic power plant and operation method therefor

(76) Inventors: Wolfgang Schon, Langenargen (DE); Michael Roske, Friedrichshafen (DE); Martin Lamke, Ravensburg (DE); Uwe Griesmeier, Markdorf (DE); Axel-Michael Muller, Friedrichshafen (DE); Stefan Wallner, Friedrichshafen (DE); Notker Amann, Friedrichshafen (DE)

Correspondence Address: DAVIS & BUJOLD, P.L.L.C., 112 PLEASANT STREET, CONCORD, NH, 03301, US

(21) Appl. No.: 11/510,338

(22) Filed: Aug. 25, 2006

(30) Foreign Application Priority Data
Aug. 25, 2005 (DE) 10 2005 040 153.8

(51) Int. Cl. B60W 10/02; B60K 6/00; F16H 3/62

(52) U.S. Cl. 475/275; 477/5; 180/65.2

(57) ABSTRACT

A transmission for a vehicle equipped with an electrodynamic starting element or an electrodynamic power plant (1) and an electrodynamic starting element or an electrodynamic power plant (1) having an electric motor (2) and a planetary transmission (5) located between the internal combustion engine (4) and the transmission (3) in which the reverse gear is implemented by adequate adjustment of the electric motor (2) of the electrodynamic starting element or of the electrodynamic power plant (1) so that the vehicle is driven in reverse gear by the electric motor (2), the mechanical parts required for the reverse gear with the internal combustion engine (4) being eliminated.

This application claims priority from German Application Serial No. 10 2005 040 153.8 filed Aug. 25, 2005

### Field of the Invention

The instant invention concerns a system comprising of one transmission for a vehicle equipped with at least an electrodynamic starting element or an electrodynamic power plant. The invention further refers to a method for implementing the reverse gear for the inventive system.

### BACKGROUND OF THE INVENTION

Electrodynamic power plants or starting elements are known from the prior art and are customarily used in vehicles having an automated mechanical transmission to make a wear-free starting possible. As a rule, they comprise an electric motor and a planetary transmission located between the internal combustion engine and the transmission and it is possible in some designs to provide a clutch for by-passing the planetary transmission. In relation to an automated mechanical transmission, the electrodynamic starting element performs all the drive train functions required for operating an LKW such as starting, shunting and shifting. The use of the electric motor makes other functions advantageously possible, such as starting of the internal combustion engine, supply of the main power system with electric energy, recovery of braking energy with electric accumulator and assistance of the internal combustion engine during the acceleration operations.

Within the scope of the Applicant's DE 199 34 696 A1 is described an electrodynamic power plant for a vehicle which comprises a planetary transmission situated between a prime mover and a mechanical transmission having one sun gear, one hollow gear and one planet carrier wherein the planet carrier is connected with the mechanical transmission and the hollow gear with the prime mover. In this construction, the sun gear is connected with an electric motor and an electric eddy current retarder so that by way of this arrangement, the prime mover can be started, electric energy generated and the vehicle electrically braked. Starting of the vehicle is also possible from the prior art.

From the Applicant's DE 101 52 481 A1, another electrodynamic power plant for a vehicle is also known, having one mechanical transmission and one planetary transmission comprising the elements of a sun gear, a hollow gear and a planet carrier of which a first element is connected with an output shaft, a second element with a prime mover of the vehicle and a third element with an electric motor and a continuously operating brake in the form of an eddy current brake. The system further comprises a control and a shifting device which has a first shifting position in which there is a non-rotatable connection between two elements of the planetary transmission for by-passing the planetary transmission. The connection between both elements of the planetary transmission is interrupted in a second shifting position. The shifting device has a third shifting position in which there is a non-rotatable connection between the third element of the planetary transmission and a fixed housing part. One rotor of the eddy current brake is situated on the element connected with the shifting device which interacts with a stator located on the housing part and the planetary transmission is situated on an output shaft at the output of the mechanical transmission. The element connected with the shifting device is preferably the hollow gear of the planetary transmission. To by-pass the planetary transmission, the hollow gear and the planet carrier are non-rotatably interconnected.

The Applicant's DE 101 52 471 A1 discloses a method for starting an internal combustion engine of a vehicle, equipped with an electrodynamic power plant which comprises a planetary transmission between the internal combustion engine and a mechanical transmission. It is provided here that the electric motor be accelerated to a rotational speed basically sufficient to start the internal combustion engine and that thereafter results a regulated engaging of a brake which decelerates the rotation of the input shaft of the mechanical transmission against a stationary housing part whereby a torque acts upon the internal combustion engine as summation of electric torque and rotating torque of the rotating parts.

In the solutions known from the prior art, the installation space and weight are not optimized, since a conventional dog-clutch automated mechanical transmission is combined with an electrodynamic power plant or electrodynamic starting element.

The problem on which this invention is based is to outline a system comprising a transmission for a vehicle equipped with an electrodynamic starting element or an electrodynamic power plant and an electrodynamic starting element or an electrodynamic power plant comprising one electric motor and one planetary transmission which are situated between the internal combustion engine and the transmission in which, as a result of the integration of other drive train functions in the electrodynamic starting element, the mechanical parts are reduced. A method is further outlined for implementing the reverse gear for the inventive system.

### SUMMARY OF THE INVENTION

Accordingly, a system is proposed comprising a transmission for a vehicle equipped with one electrodynamic starting element and one electrodynamic power plant and an electrodynamic power plant comprising one electric motor and one planetary transmission which are situated between the internal combustion engine and the transmission in which the reverse gear is implemented by adequate adjustment of the electric motor of the electrodynamic starting element and of the electrodynamic power plant so that the vehicle is driven by the electric motor in reverse gear. The mechanical parts required for reverse motion are eliminated with the internal combustion engine.

The length of the transmission can be reduced by the inventive draft, this is of special advantage for installation in vehicles with a very short wheel base as is the case, for example, in saddle tractors. In addition, the achievable reduced length of the transmission can be used to lengthen the clutch bell housing so that it is possible to install an electric motor of stronger power. The transmission shafts also can be designed shorter and smaller bearing spaces whereby a small shaft bending results which, in turn, results in advantages relative to the inclined position within the shaft bearings and thus in an increase of the service life of the bearing.

### BRIEF DESCRIPTION OF THE DRAWINGS

The invention will now be described, by way of example, with reference to the accompanying drawings in which:

FIG. 1 is a diagrammatic representation of a transmission having one electrodynamic starting element and one electrodynamic power plant according to the prior art;

FIG. 2 is a diagrammatic representation of another embodiment of a transmission having one electrodynamic starting element and one electrodynamic power plant according to the prior art;

FIG. 3 is a diagrammatic representation of a preferred embodiment of a transmission having one electrodynamic starting element and one electrodynamic power plant according to the invention;

FIG. 4 is a characteristic field of an electric motor of an electrodynamic starting element and of an electrodynamic power plant; and

FIG. 5 is a rotational speed curve of the internal combustion engine, of the electric motor 19 and the curve of the input rotational speed of the mechanical transmission in reverse gear according to the invention.

### DETAILED DESCRIPTION OF THE INVENTION

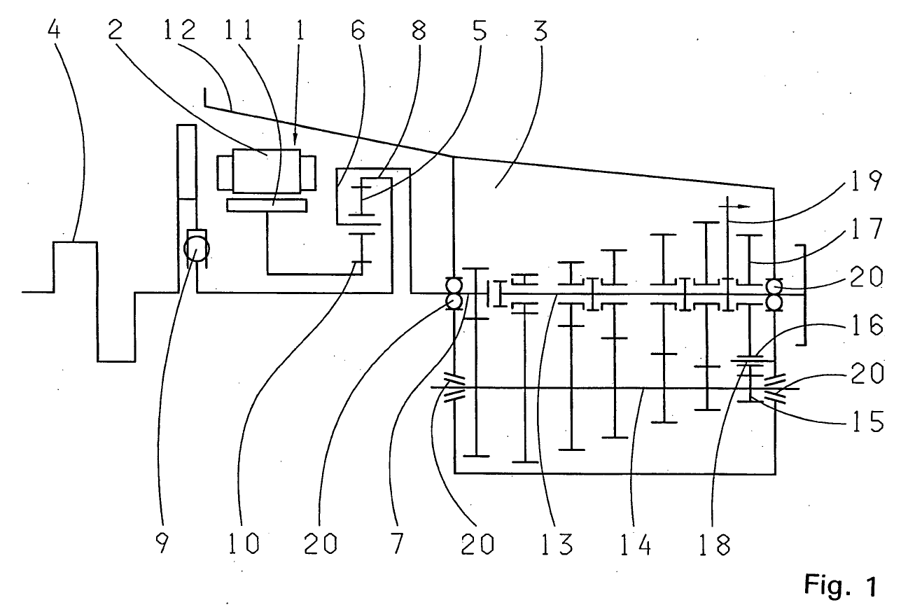

In FIG. 1, a transmission is shown having an electrodynamic starting element or an electrodynamic power plant 1 according to the prior art. An electric motor 2 is situated in a clutch bell housing 12 and an automated mechanical transmission 3. Between an internal combustion engine 4 and the transmission 3 is located a planetary transmission 5 serving as a summarizing transmission whose planet carrier 6 is connected with the transmission input shaft 7. A hollow gear 8 of the planetary transmission 4, via a damping element 9, and a sun gear 10 is connected with a rotor 11 of the electric motor 2.

The design of the conventional transmission 3 is known to the expert.

It comprises one main shaft 13, one countershaft 14 with several fixed and idler wheels. To implement the reverse gear, on the countershaft 14 is provided a reverse gear wheel 15 with a corresponding bearing 18 which meshes with an intermediate gear 16 which is in gear with an idler wheel 17 on the main shaft 13.

To engage the reverse gear, a shifting device 19 is provided. The anti-friction bearings of the shafts are provided with the reference numeral 20 in the Figure.

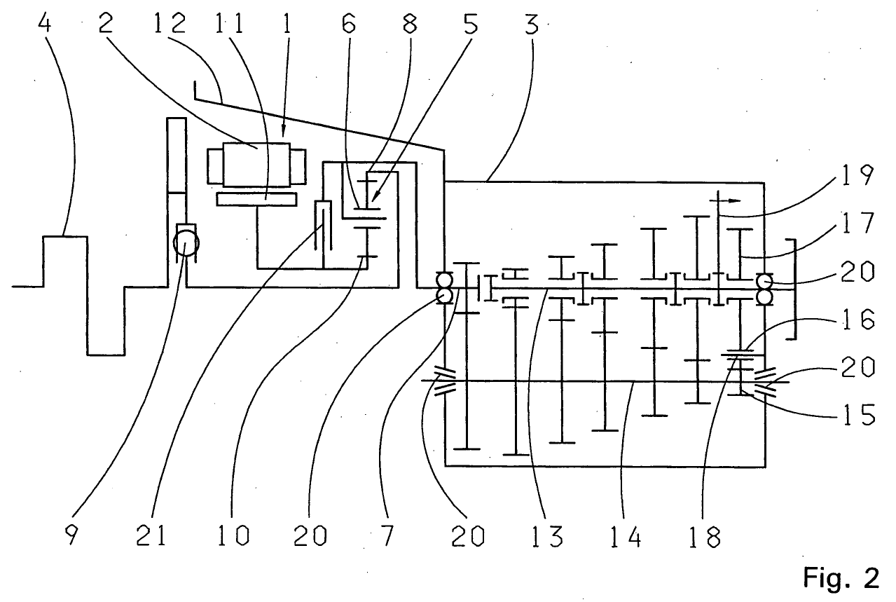

In FIG. 2 is shown another embodiment of a transmission with an electrodynamic starting element and an electrodynamic power plant according to the prior art. The only difference from the embodiment shown in FIG. 1 is that one clutch 21 is provided for by-passing the planetary transmission 5. It loosely interconnects the sun gear 10 with the planet carrier 6 so that the planetary transmission 5 rotates in block operation.

According to the invention, the reverse gear is implemented by adequate adjustment of the electric motor of the electrodynamic starting element and of the electrodynamic power plant so that in reverse gear the vehicle is driven by the electric motor.

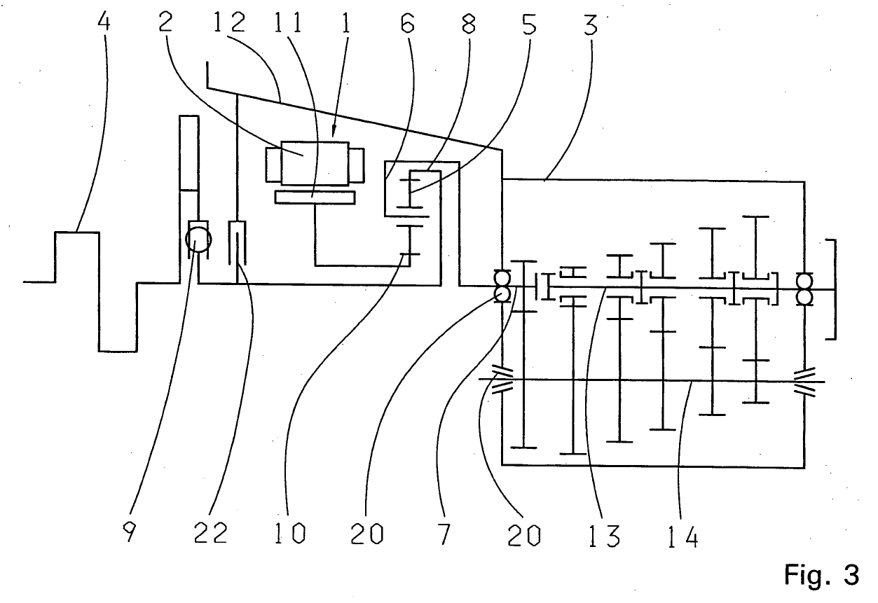

According to a preferred embodiment of the invention, a transmission is proposed which has one electrodynamic starting element or one electrodynamic power plant in which a crankshafts retaining device 22 is provided by way of which the crankshaft of the internal combustion engine 4 is retained in the reverse gear operation. The crankshaft retaining device 22 can be designed, for example, as a brake by way of which the crankshaft of the internal combustion engine 4 can be coupled on the housing or on the clutch bell housing 12. This is the object of the embodiment of FIG. 3 where the crankshafts retaining device is provided with the reference numeral 22.

Since the electric motor can be operated in a four quadrant operation, it is possible to entirely electrically drive forward and in reverse. By the fact that it is possible to electrically drive in reverse, the construction of the automated mechanical transmission is simplified. As can be seen from comparing FIG. 3 with FIGS. 1 and 2, all mechanical parts required for reverse gear with the internal combustion engine 4 are eliminated. In particular the idler wheel 17 on the main shaft 13, the reverse gear, gearwheel 15 on the countershaft 14, the intermediate gear 16 are eliminated, including the intermediate gear bearing 18 and the appertaining shifting device 19.

To engage the reverse gear, the procedure is the following: the vehicle is stopped, and during the stopping operation, if needed, it is shifted back to reverse until the first or second gear is activated. By engaging the reverse gear switch on the vehicle side, the internal combustion engine is shut off and subsequently the retaining device 22 for the crankshaft is closed. According to the invention, starting from this moment the accelerator pedal performs the function of an electric nominal value sensor for the electric motor 2 which is connected via the planetary transmission 5 with the input shaft 7 of the transmission 3. If the driver gives gas, the vehicle accelerates in reverse until reaching the final speed given by the power of the electric motor 2 and ratios of the planetary transmission 5, of the first gear or of the second gear and of the driven vehicle axle. Should a higher vehicle speed be required, it is possible to use other gears of the mechanical transmission.

The reverse gear can be implemented by an adequate adjustment of the electric motor also without need of the crankshafts retaining device 22, as shown in FIG. 3.

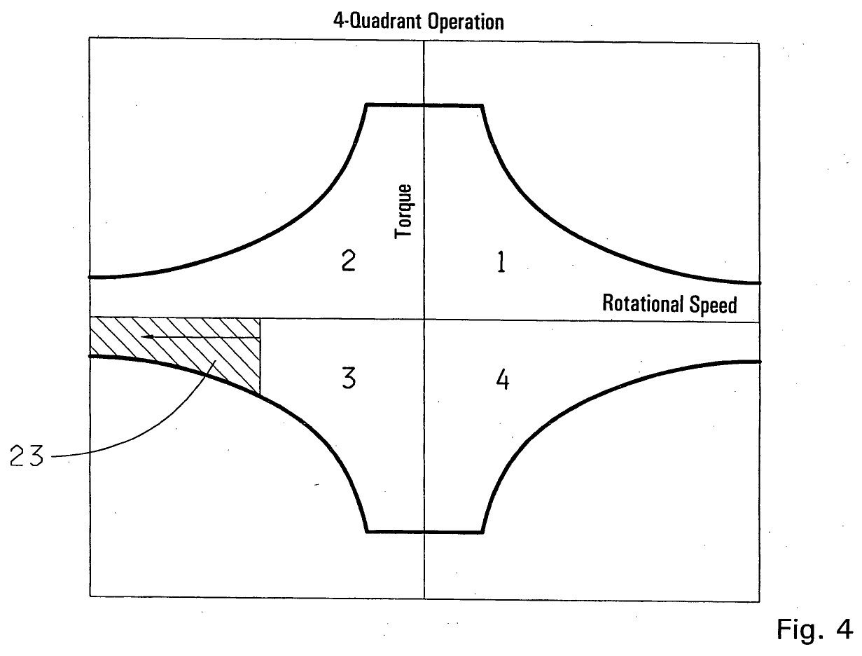

To this end, the vehicle is stopped, it being shifted back during the stop operation until the first or the second gear is activated. When the vehicle is stationary, the internal combustion engine 4 rotates further with idling rotational speed and the electric motor 2 is selected so that when the accelerator pedal is actuated, there is used one part 23 (operation range) of the third quadrant of the characteristic field of the electric motor, as illustrated in FIG. 4. In this way, the electric motor 2 is accelerated opposite to the direction of rotation of the internal combustion engine.

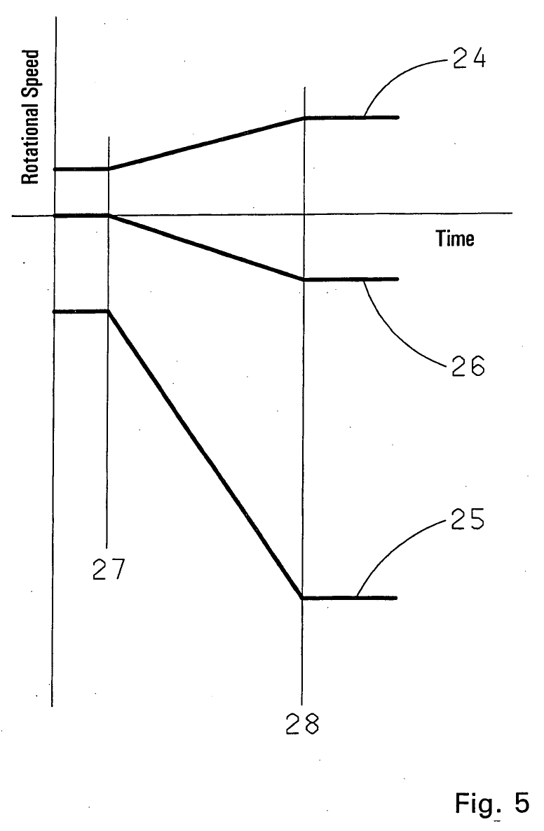

In FIG. 5, a rotational speed curve 24 of the internal combustion engine 4, a rotational speed curve 25 or the electric motor 2 is shown as a function of time, and the curve of an input rotational speed 26 of the mechanical transmission 3.

The initial situation is the stationary vehicle wherein the internal combustion engine rotates at idle rotational speed. At a moment 27 (start of the acceleration in reverse), the driver presets with regulated rotational speed, via the accelerator pedal, the rotational speed curve 26 of the transmission input. Subsequently the internal combustion engine 4 accelerates according to the freely parameterized rotational speed curve 24 shown and the electric motor 2 accelerates in the opposite direction of rotation, likewise, at the rate firmly preset by the planetary transmission 5. The rotational speed on the input of the transmission is increased opposite to the direction of rotation of the internal combustion engine and the vehicle moves in reverse gear. At the moment 28, the rotational speeds change no more. This moment corresponds to the start of a constant reverse gear.

Every structural design, especially every spatial arrangement of the parts of the transmission and of the electrodynamic starting element or power plant per se or relative to each other and if technically important evidently fall under the scope of protection of these claims without affecting the function of the transmission, such as outlined in the claims, even if those designs have not been explicitly shown in the Figures or in the description.

Reference Numerals

1 electrodynamic power plant
2 electric motor
3 mechanical transmission
4 internal combustion engine
5 planetary transmission
6 planet carrier
7 transmission input shaft
8 hollow gear reverse gear
9 damping element
10 sun gear combustion engine
11 rotor
12 clutch bell housing
13 main shaft input
14 countershaft
15 reverse gear wheel
16 intermediate gear
17 idler gear
18 bearing of reverse gear wheel
19 shifting device
20 antifriction bearing
21 clutch
22 retaining device for crankshaft
23 operation range of the electric motor in
24 rotational speed curve of the internal
25 rotational speed curve of the electric motor
26 rotational speed curve of the transmission
27 start of reverse gear acceleration
28 start of a constant reverse gear

1-7. (canceled)

8. A vehicle system comprising a transmission for a vehicle equipped with one of an electrodynamic starting element and an electrodynamic power plant and one of the electrodynamic starting element and the electrodynamic power plant having an electric motor and a planetary transmission located between the internal combustion engine and the transmission, a reverse gear being implemented by adequate adjustment of the electric motor (2) of one of the electrodynamic starting element and of the electrodynamic power plant (1) such that the vehicle is driven in reverse gear by the electric motor (2).

9. The vehicle system according to claim 8, wherein a crankshaft retaining device (22) is provided to lock a crankshaft of the internal combustion engine (4) in a reverse gear operation.

10. The vehicle system according to claim 9, wherein the crankshaft retaining device (22) is a brake by which the crankshaft of the internal combustion engine (4) is coupled to at least one of a transmission housing or a clutch bell housing (12).

11. The vehicle system according to claim 8, wherein a reduced vehicle system length achieved as a result of elimination of mechanical parts required for reverse drive with the internal combustion engine (4) is used to lengthen a clutch bell housing (12) so that the electric motor (2), having a stronger power, is installed.

12. A method for implementing the reverse gear in a vehicle system comprising a transmission for a vehicle equipped with one of an electrodynamic starting element and an electrodynamic power plant and one of the electrodynamic starting element and the electrodynamic power plant having an electric motor and a planetary transmission located between the internal combustion engine and the transmission, a reverse gear being implemented by adequate adjustment of the electric motor (2) of one of the electrodynamic starting element and of the electrodynamic power plant (1) such that the vehicle is driven in reverse gear by the electric motor (2), the method comprising the steps of:
activating one of a first gear and a second gear while the vehicle is one of performing a stopping operation and stopped;
rotating the internal combustion engine, when the vehicle is stopped and no crankshaft retaining device (22) is provided, at an idle rotational speed and driving the electric motor (2) via the planetary transmission (5) connected with the transmission input, opposite to a direction of rotation of the internal combustion engine; and
selecting a mode of operation of the electric motor (2) by switching in the reverse gear switch on a vehicle side, so that when an accelerator pedal is actuated, one part (23) of a third quadrant of a characteristic field of the electric motor is used so that the electric motor (2) accelerates in an opposite direction to rotation of the internal combustion engine.

13. A method for implementing the reverse gear in a vehicle system comprising a transmission for a vehicle equipped with one of an electrodynamic starting element and an electrodynamic power plant and one of the electrodynamic starting element and the electrodynamic power plant having an electric motor and a planetary transmission located between the internal combustion engine and the transmission, a reverse gear being implemented by adequate adjustment of the electric motor (2) of one of the electrodynamic starting element and of the electrodynamic power plant (1) such that the vehicle is driven in reverse gear by the electric motor (2), the method comprising the steps of:
activating one of a first gear and a second gear vehicle while the vehicle is one of stopped and stopping;
when a crankshaft retaining device (22) is provided, engaging a reverse gear switch on a vehicle side, to shut off the internal combustion engine (4) and engage the retaining device (22) for the crankshaft; and
enabling an accelerator pedal to perform a function of an electric nominal value sensor for the electric motor (2) connected via the planetary transmission (5) with the input shaft (7) of the transmission (3), such that when a driver depresses an accelerator pedal, the vehicle accelerates in the reverse gear.

14. The method for implementing the reverse gear according to claim 12, further comprising the step of giving the speed in the reverse gear by power of the electric motor (2) and ratios of the planetary transmission (5), of the first gear or of the second gear and driven vehicle axle.
